(19) United States
(12) Patent Application Publication
(10) Pub. No.: US 2022/0209554 A1
(43) Pub. Date: Jun. 30, 2022

(54) PORTABLE CHARGING DEVICE

(71) Applicant: Waltop International Corporation, HSINCHU CITY (TW)

(72) Inventors: HUNG-I WANG, New Taipei City (TW); YI-CHIH CHANG, Hsinchu City (TW); CHIA-JUI YEH, Hsinchu (TW)

(21) Appl. No.: 17/213,090

(22) Filed: Mar. 25, 2021

(30) Foreign Application Priority Data
Dec. 30, 2020 (TW) 109217323

(51) Int. Cl. H02J 7/00; G06F 3/0354

(52) U.S. Cl. CPC H02J 7/0042; G06F 3/03545; H02J 7/0047

(57) ABSTRACT

A portable charging device is provided. The portable charging device includes a stylus module and a charging module. The stylus module includes a stylus body unit and a power supply unit. The power supply unit is arranged in the stylus body unit. The charging module includes a casing unit, a control unit, and a power storage unit. The casing unit includes an opening, a first accommodating space, and a second accommodating space. The opening is communicated with the first accommodating space, and the first accommodating space is adjacent to the second accommodating space. The control unit is arranged in the second accommodating space. The power storage unit is arranged in the second accommodating space and electrically connected to the control unit. The stylus body unit is detachably arranged in the first accommodating space, and the power supply unit is electrically connected to the control unit.

### CROSS-REFERENCE TO RELATED PATENT APPLICATION

This application claims the benefit of priority to Taiwan Patent Application No. 109217323, filed on Dec. 30, 2020. The entire content of the above identified application is incorporated herein by reference.

Some references, which may include patents, patent applications and various publications, may be cited and discussed in the description of this disclosure. The citation and/or discussion of such references is provided merely to the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a portable charging device, and more particularly to a portable charging device for accommodating a stylus and charging the stylus.

### BACKGROUND OF THE DISCLOSURE

Nowadays, touchscreens are widely applied on electronics, e.g., smart phones, tablet computers, graphics tablets, etc., while styluses are indispensable auxiliary tools for the touchscreens, so as to help a user to more easily write, annotate, draw, etc., on the touchscreens.

Since small sized styluses can be easily misplaced, some of the manufacturers for portable electronic devices provide electronic devices that can accommodate styluses therein, and the electronic devices usually each have an accommodating hole that is sufficiently deep for accommodating the styluses. However, in order to reserve space for the accommodating holes, a height, a width, and a thickness of the electronic devices are inevitably increased, making them appear bulky and increasing a manufacturing cost of the electronic devices.

In addition, no independent stylus accommodating devices for stylus accommodating or stylus charging are currently commercially available.

SUMMARY OF THE DISCLOSURE

In response to the above-referenced technical inadequacies, the present disclosure provides a portable charging device.

In one aspect, the present disclosure provides a portable charging device including a stylus module and a charging module. The stylus module includes a stylus body unit and a power supply unit arranged in the stylus body unit. The charging module includes a casing unit, a control unit, and a power storage unit. The casing unit includes an opening, a first accommodating space, and a second accommodating space, the opening is communicated with the first accommodating space, and the first accommodating space is adjacent to the second accommodating space. The control unit is arranged in the second accommodating space. The power storage unit is arranged in the second accommodating space and is electrically connected to the control unit. The stylus body unit is detachably arranged in the first accommodating space, and the power supply unit is electrically connected to the control unit.

In another aspect, the present disclosure provides a portable charging device including a stylus module and a charging module. The stylus module includes a stylus body unit and a power supply unit arranged in the stylus body unit. The charging module includes a casing unit, a control unit, and a receiving unit. The casing unit includes an opening, a first accommodating space, and a second accommodating space, the opening is communicated with the first accommodating space, and the first accommodating space is adjacent to the second accommodating space. The control unit is arranged in the second accommodating space. The receiving unit is disposed on a main body of the casing unit, and the receiving unit is electrically connected to the control unit. The stylus body unit is detachably arranged in the first accommodating space, and the power supply unit is electrically connected to the control unit. When the receiving unit receives power from an external power supply, the control unit provides the power to the power supply unit.

One of the beneficial effects of the portable charging device of the present disclosure is that the portable charging device is able to accommodate the stylus and charge the stylus through the above-mentioned technical solutions.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic structural view of a portable charging device according to a first embodiment of the present disclosure;

FIG. 2 is a schematic perspective view of the portable charging device according to the first embodiment of the present disclosure;

FIG. 3 is a cross-sectional view taken along line III-III of FIG. 2;

FIG. 4 is a functional block diagram of the portable charging device according to the first embodiment of the present disclosure;

FIG. 5 is a schematic perspective view of a charging module of the portable charging device according to a second embodiment of the present disclosure;

FIG. 6 is a first schematic view showing the charging module of the portable charging device in use according to the second embodiment of the present disclosure;

FIG. 7 is a second schematic view showing the charging module of the portable charging device in use according to the second embodiment of the present disclosure;

FIG. 8 is a functional block diagram of the charging module of the portable charging device according to the second embodiment of the present disclosure;

FIG. 9 is a schematic view showing the portable charging device in use according to a third embodiment of the present disclosure;

FIG. 10 is a functional block diagram of the portable charging device according to the third embodiment of the present disclosure; and

FIG. 11 is a schematic view showing the charging module in use according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

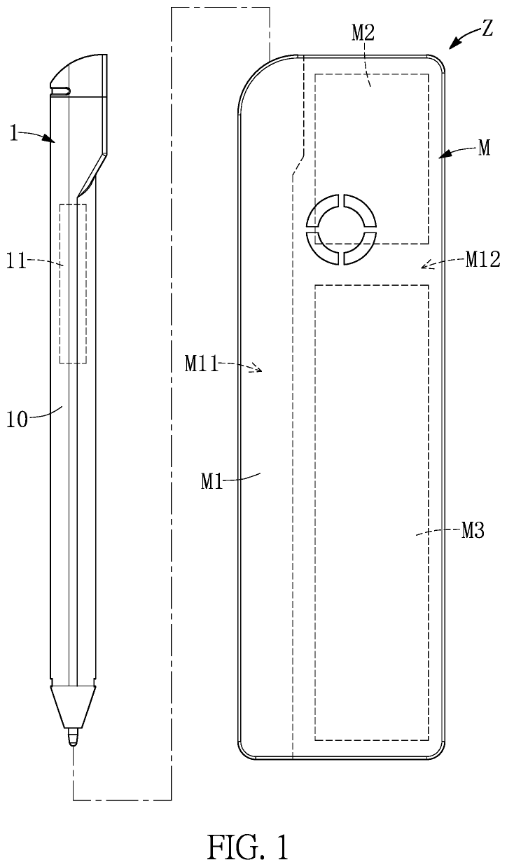

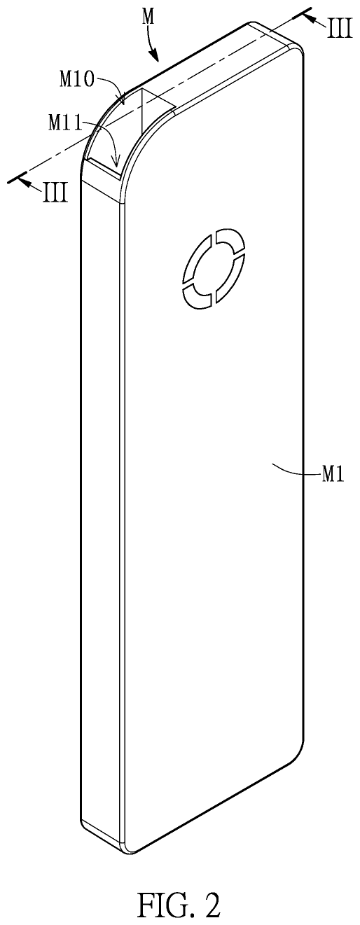

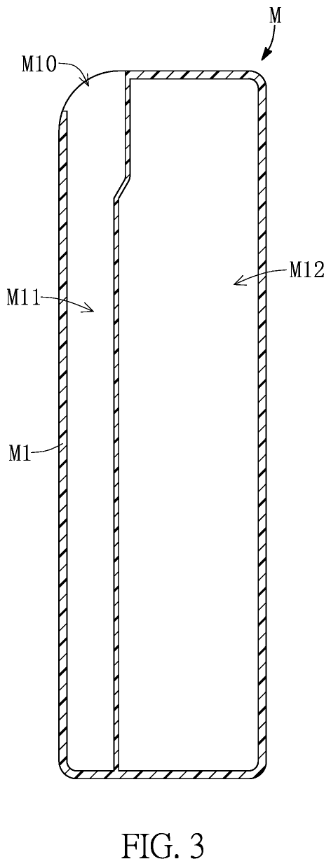

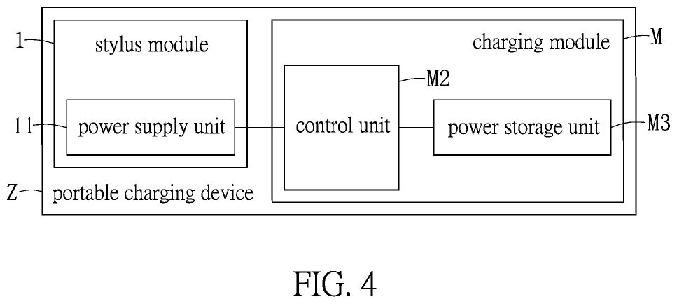

References are made to FIG. 1 to FIG. 4. FIG. 1 is a schematic structural view of a portable charging device according to a first embodiment of the present disclosure. FIG. 2 is a schematic perspective view of the portable charging device according to the first embodiment of the present disclosure. FIG. 3 is a cross-sectional view taken along line III-III of FIG. 2. FIG. 4 is a functional block diagram of the portable charging device according to the first embodiment of the present disclosure. As shown in the figures, the first embodiment of the present disclosure provides a portable charging device Z, which includes a stylus module 1 and a charging module M.

As shown in FIG. 1, the stylus module 1 can include a stylus body unit 10 and a power supply unit 11. The power supply unit 11 is arranged in the stylus body unit 10. For example, the stylus module 1 can be a stylus. The stylus body unit 10 includes the power supply unit 11 arranged therein, and the power supply unit 11 can be a battery that can be repeatedly charged and discharged, but the present disclosure is not limited thereto.

Next, as shown in FIG. 1 to FIG. 3, the charging module M can include a casing unit M1, a control unit M2, and a power storage unit M3. For example, the casing unit M1 can be a housing structure, and a first accommodating space M11 and a second accommodating space M12 can be formed adjacent to each other inside the casing unit M1. The first accommodating space M11 and the second accommodating space M12 can be separate from each other, but the present disclosure is not limited thereto. An edge of the casing unit M1 has an opening M10, and the opening M10 is communicated with the first accommodating space M11. The control unit M2 can be arranged in the second accommodating space M12. The control unit M2 can be a circuit board having functions of processing and controlling, but the present disclosure is not limited thereto. The power storage unit M3 is arranged in the second accommodating space M12, and the power storage unit M3 is electrically connected to the control unit M2. The power storage unit M3 can be a battery that can be repeatedly charged and discharged, but the present disclosure is not limited thereto.

Therefore, the stylus body unit 10 is detachably arranged in the first accommodating space M11, and the power supply unit 11 is electrically connected to the control unit M2. For example, as shown in FIG. 1 to FIG. 4, when the stylus module 1 is placed in the first accommodating space M11 through the opening M10, the power supply unit 11 of the stylus module 1 can be electrically connected to the control unit M2 of the charging module M, and the control unit M2 can supply the power of the power storage unit M3 to the power supply unit 11, so that the power supply unit 11 can be charged. When using the stylus module 1, the stylus module 1 can be directly taken out from the charging module M.

In this way, through the above-mentioned technical solutions, the portable charging device Z provided by the present disclosure can not only accommodate the stylus module 1 by the first accommodating space M11, but also supply the power of the power storage unit M3 to the stylus module 1 through the control unit M2 to charge the stylus module 1.

It is worth mentioning that the stylus module 1 and the charging module M can include metal terminals or metal contacts (not shown in the figures), so that when the stylus module 1 is placed inside the first accommodating space M11, the stylus module 1 and the charging module M can be in contact with each other through the metal contacts, so that the power supply unit 11 of the stylus module 1 can be electrically connected to the control unit M2 of the charging module M.

### Second Embodiment

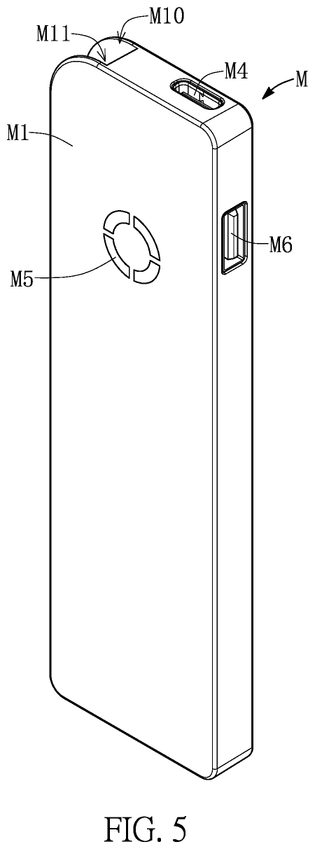

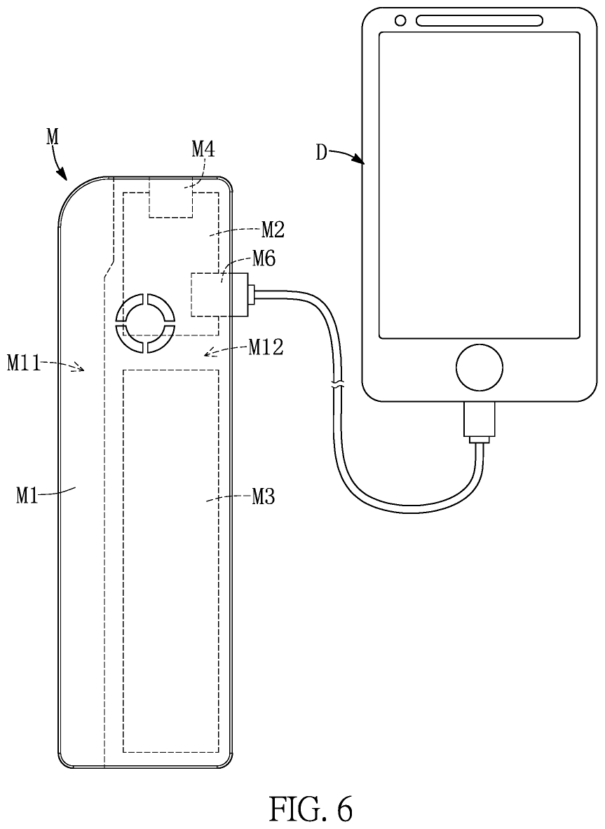

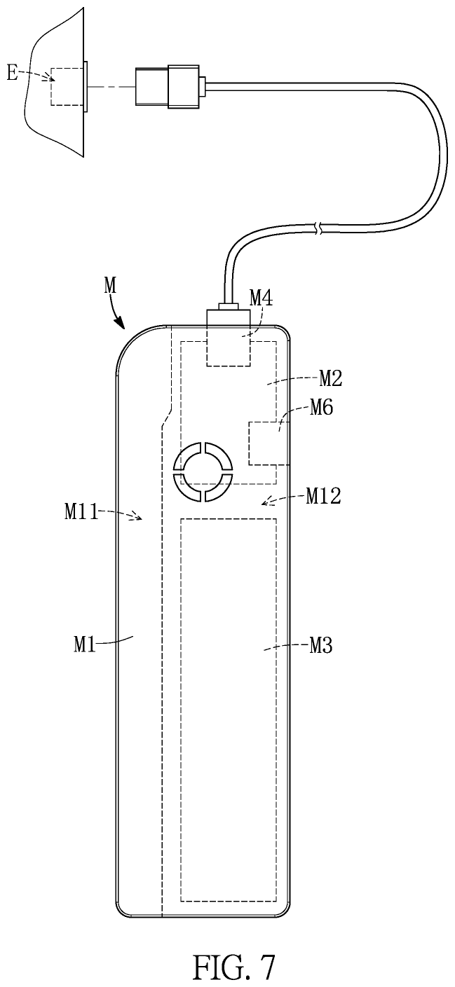

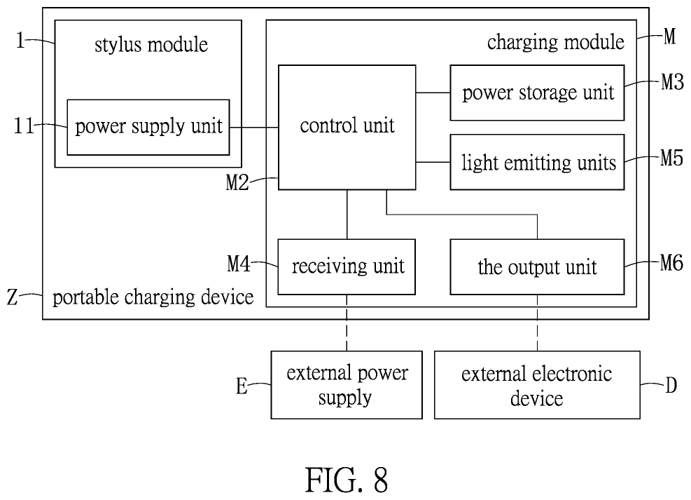

References are made to FIG. 5 to FIG. 8, and are to be read in conjunction with FIG. 1 to FIG. 4. FIG. 5 is a schematic perspective view of a charging module of the portable charging device according to a second embodiment of the present disclosure. FIG. 6 is a first schematic view showing the charging module of the portable charging device in use according to the second embodiment of the present disclosure. FIG. 7 is a second schematic view showing the charging module of the portable charging device in use according to the second embodiment of the present disclosure. FIG. 8 is a functional block diagram of the charging module of the portable charging device according to the second embodiment of the present disclosure. As shown in the figures, similar components of the portable charging device Z of the second embodiment have a similar manner of operation to that of the portable charging device Z of the first embodiment, and will not be reiterated herein. It is worth noting that, in the second embodiment, the charging module M can further include a receiving unit M4, which is disposed on a main body of the casing unit M1, and the receiving unit M4 is electrically connected to the control unit M2.

As shown in FIG. 5, FIG. 7, and FIG. 8, for example, the receiving unit M4 can be a universal serial bus (USB) interface connector, and the receiving unit M4 can be disposed on an outer edge of the casing unit M1, but the present disclosure is not limited thereto. Therefore, the receiving unit M4 can be connected to an external power supply E (e.g., a plug or a power supply, but not limited thereto) through a transmission wire (not labeled in the figures), and the control unit M2 can be used to supply power provided by the external power supply E to the power supply unit 11, so that the power supply unit 11 can be charged. In addition, the receiving unit M4 can also supply the power provided by the external power supply E to the power storage unit M3 through the control unit M2, so that the power storage unit M3 can be charged.

Furthermore, the charging module M can further include a plurality of light emitting units M5, which are arranged on the main body of the casing unit M1, and the light emitting units M5 are electrically connected to the control unit M2, and at least one of the light emitting units M5 emits a beam through being controlled by the control unit M2.

For example, as shown in FIG. 5 and FIG. 8, each of the light emitting units M5 can be a light emitting element having a light-emitting diode (LED). In the second embodiment, a quantity of the light emitting units M5 is exemplified as four, but the present disclosure is not limited thereto. Therefore, when the power storage unit M3 of the charging module M provides power to the power supply unit 11 of the stylus module 1, or when the power storage unit M3 performs charging, the control unit M2 can control a manner of display of the light emitting units M5, such that a user acknowledges a current charging state of the power supply unit 11, or a current charging state of the power storage unit M3. In addition, in a non-charging state, the control unit M2 can also control the manner of display of the light emitting units M5, such that the user acknowledges a current power state of the power supply unit 11 or a current power state of the power storage unit M3. In addition, one of or both of the stylus module 1 and the charging module M can include a power detection element (not shown in the figures), so that the control unit M2 can obtain the power state of the power supply unit 11 and the power state of the power storage unit M3.

Furthermore, the charging module M may further include an output unit M6 disposed on the main body of the casing unit M1, and the output unit M6 is electrically connected to the control unit M2. When the output unit M6 is connected to an external electronic device D, the output unit M6 provides the power of the power storage unit M3 to the external electronic device D.

For example, as shown in FIG. 5, FIG. 6, and FIG. 8, the output unit M6 can be a USB interface connector, and the output unit M6 can be disposed on the outer edge of the casing unit M1, but the present disclosure is not limited thereto. Therefore, the output unit M6 can be connected to an external electronic device D (e.g., a tablet computer or a smart phone, but not limited thereto) through a transmission wire (not labeled in the figures), and the control unit M2 and the output unit M6 provides the power of the power storage unit M3 to the external electronic device D, so that the external electronic device D can be charged.

### Third Embodiment

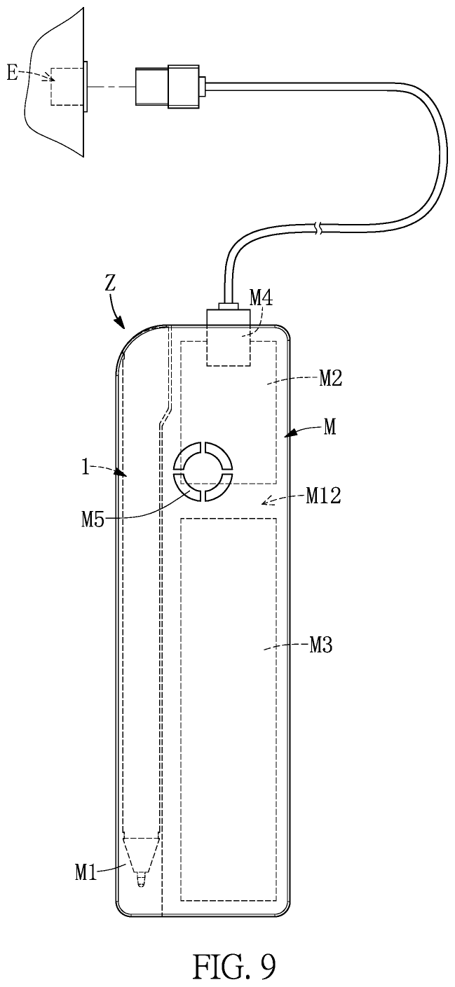

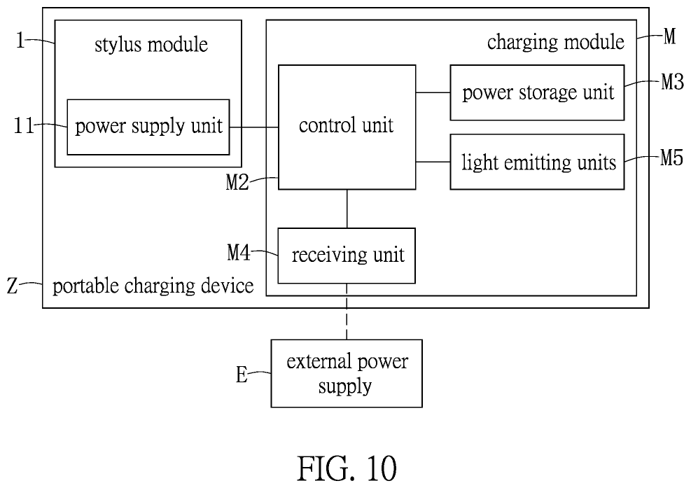

References are made to FIG. 9 and FIG. 10, and are to be read in conjunction with FIG. 1 to FIG. 8. FIG. 9 is a schematic view showing the portable charging device in use according to a third embodiment of the present disclosure. FIG. 10 is a functional block diagram of the portable charging device according to the third embodiment of the present disclosure. As shown in the figures, the third embodiment of the present disclosure provides a portable charging device Z, which includes a stylus module 1 and a charging module M. The stylus module 1 includes a stylus body unit 10 and a power supply unit 11. The power supply unit 11 is arranged in the stylus body unit 10. The charging module M includes a casing unit M1, a control unit M2, and a receiving unit M4. The casing unit M1 has an opening M10, a first accommodating space M11, and a second accommodating space M12. The opening M10 is communicated with the first accommodating space M11, and the first accommodating space M11 and the second accommodating space M12 are adjacent to each other. The control unit M2 is arranged in the second accommodating space M12. The receiving unit M4 is disposed on a main body of the casing unit M1, and the receiving unit M4 is electrically connected to the control unit M2. The stylus body unit 10 is detachably arranged in the first accommodating space M11, and the power supply unit 11 is electrically connected to the control unit M2. When the receiving unit M4 receives the power provided by an external power supply E, the control unit M2 supplies the power to the power supply unit 11.

Specifically speaking, comparing FIG. 9 and FIG. 10 with FIG. 1 and FIG. 4, it can be observed that a difference between the third embodiment and the aforementioned first embodiment is that the charging module M of the third embodiment can include a receiving unit M4, but does not include a power storage unit M3. The receiving unit M4 can be a USB interface connector, and the receiving unit M4 can be disposed on an outer edge of the casing unit M1, but the present disclosure is not limited thereto.

Therefore, as shown in FIG. 9 and FIG. 10, when the stylus module 1 is placed in the first accommodating space M11 through the opening M10, the power supply unit 11 of the stylus module 1 can be electrically connected to the control unit M2 of the charging module M. Afterwards, when the receiving unit M4 is connected to the external power supply E through a transmission wire (not labeled in the figures), the control unit M2 can supply the power provided by the external power supply E to the power supply unit 11, so that the power supply unit 11 can be charged. When using the stylus module 1, the stylus module 1 can be directly taken out from the charging module M.

Therefore, through the above-mentioned technical solutions, the portable charging device Z provided by the present disclosure can not only receive the stylus module 1 through the first accommodating space M11, but also charge the stylus module 1 through the receiving unit M4 and the external power supply E being connected to each other and the control unit M2 supplying the power provided by the external power supply E to the stylus module 1.

Furthermore, the charging module M further includes a plurality of light emitting units M5, which are arranged on the main body of the casing unit M1. The light emitting units M5 are electrically connected to the control unit M2, and at least one of the light emitting units M5 emits a beam through being controlled by the control unit M2.

For example, as shown in FIG. 9 and FIG. 10, each of the light emitting units M5 can be a light emitting element having a light-emitting diode. In the third embodiment, a quantity of the light emitting units M5 is exemplified as four, but the present disclosure is not limited thereto. Therefore, when the power storage unit M3 of the charging module M provides power to the power supply unit 11 of the stylus module 1, the control unit M2 can control a manner of display of the light emitting units M5, such that the user acknowledges a current charging state of the power supply unit 11. In addition, in a non-charging state, the control unit M2 can also control the manner of display of the light emitting units M5, such that the user acknowledges a current power state of the power supply unit 11.

### Fourth Embodiment

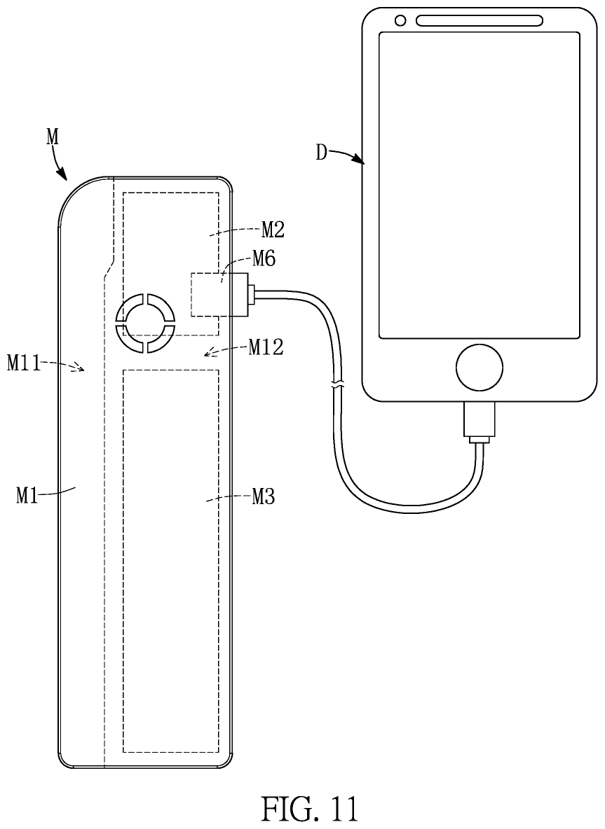

Reference is made to FIG. 11, which is to be read in conjunction with FIG. 1 to FIG. 10. FIG. 11 is a schematic view showing the charging module in use according to a fourth embodiment of the present disclosure. As shown in the figures, the fourth embodiment of the present disclosure provides a charging module M, which includes a casing unit M1, a control unit M2, a power storage unit M3, and an output unit M6. The casing unit M1 has an opening M10, a first accommodating space M11, and a second accommodating space M12, the opening M10 is communicated with the first accommodating space M11, and the first accommodating space M11 and the second accommodating space M12 are adjacent to each other. The control unit M2 is arranged in the second accommodating space M12. The power storage unit M3 is arranged in the second accommodating space M12, and the power storage unit M3 is electrically connected to the control unit M2. The output unit M6 is arranged on the main body of the casing unit M1, and the output unit M6 is electrically connected to the control unit M2. When the output unit M6 is connected to an external electronic device D, the output unit M6 provides the power of the power storage unit M3 to the external electronic device D.

Specifically speaking, as shown in FIG. 11, FIG. 1, and FIG. 4, the charging module M of the present disclosure can be applied to the stylus module 1 (i.e., a stylus). The casing unit M1, the control unit M2, and the power storage unit M3 can be similar to those described in the first embodiment, and will not be reiterated herein. The output unit M6 can be a USB interface connector, and the output unit M6 can be arranged on an outer edge of the casing unit M1, but the present disclosure is not limited thereto.

Therefore, as shown in FIG. 11, when the output unit M6 is connected to the external electronic device D through a transmission wire (not labeled in the figures), the control unit M2 can supply power of the power storage unit M3 to the external electronic device D through the output unit M6, so that the external electronic device D can be charged. In other words, regardless of whether or not the stylus module 1 is accommodated in the charging module M of the present disclosure, the charging module M can serve as a mobile power device to charge the external electronic device D.

In this way, through the above-mentioned technical solutions, the charging module M provided by the present disclosure can not only store the stylus module 1 by the first accommodating space M11, but also serve as a mobile power device regardless of whether or not the stylus module 1 is accommodated in the charging module M, so as to charge the external electronic device D.

Furthermore, the charging module M further includes a receiving unit M4, which is disposed on the main body of the casing unit M1, and the receiving unit M4 is electrically connected to the control unit M2. When the receiving unit M4 receives power provided by an external power supply E, the control unit M2 supplies power to the power storage unit M3, and specific implementations thereof are similar to those described in the above-mentioned second embodiment, and will not be reiterated herein.

Furthermore, the charging module M further includes a plurality of light emitting units M5, which are arranged on the main body of the casing unit M1, and the light emitting units M5 are electrically connected to the control unit M2. At least one of the light emitting units M5 emits a beam through being controlled by the control unit M2, and specific implementations thereof are similar to those described in the above-mentioned second embodiment, and will not be reiterated herein.

However, the examples given in the above-mentioned embodiments are each only one of the feasible embodiments and are not intended to limit the present disclosure.

### Beneficial Effects of the Embodiments

One of the beneficial effects of the present disclosure is that the portable charging device Z and the charging module M provided by the present disclosure can achieve functions of storing and charging the stylus through the above-mentioned technical solutions.

Furthermore, the portable charging device Z and the charging module M provided by the present disclosure can not only receive the stylus module 1 by the first accommodating space M11, but also provide the power of the energy storage unit M3 to the stylus module 1 through the control unit M2. In addition, the stylus module 1 can be charged through the receiving unit M4 and the external power supply E being connected to each other and the control unit M2 supplying the power provided by the external power supply E to the stylus module 1. Moreover, regardless of whether or not the stylus module 1 is accommodated in the charging module M of the present disclosure, the charging module M can serve as a mobile power device to charge the external electronic device D. In addition, the portable charging device Z and the charging module M of the present disclosure can also include the light emitting units M5. The control unit M2 controls the manner of display of the light emitting units M5, such that the user can acknowledge the current charging state of the power supply unit 11, or the current charging state of the power storage unit M3. In addition, in a non-charging state, the control unit M2 can also control the manner of display of the light emitting units M5, such that the user can acknowledge the current power state of the power supply unit 11 or the current power state of the power storage unit M3.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A portable charging device, comprising:
a stylus module including:
a stylus body unit; and
a power supply unit arranged in the stylus body unit; and
a charging module including:
a casing unit including an opening, a first accommodating space, and a second accommodating space, the opening being communicated with the first accommodating space, and the first accommodating space being adjacent to the second accommodating space;
a control unit arranged in the second accommodating space; and
a power storage unit arranged in the second accommodating space and electrically connected to the control unit;
wherein the stylus body unit is detachably arranged in the first accommodating space, and the power supply unit is electrically connected to the control unit.

2. The portable charging device according to claim 1, wherein the charging module further includes a receiving unit disposed on a main body of the casing unit, the receiving unit is electrically connected to the control unit; wherein, when the receiving unit receives power from an external power supply, the control unit provides the power to the power supply unit.

3. The portable charging device according to claim 2, wherein, when the receiving unit receives the power provided by the external power supply, the control unit provides the power to the power storage unit.

4. The portable charging device according to claim 1, wherein the charging module further includes a plurality of light emitting units disposed on a main body of the casing unit, the light emitting units are electrically connected to the control unit; wherein at least one of the light emitting units emits a beam through being controlled by the control unit.

5. The portable charging device according to claim 1, wherein the charging module further includes an output unit disposed on a main body of the casing unit, and the output unit is electrically connected to the control unit; wherein, when the output unit is connected to an external electronic device, the output unit provides power of the power storage unit to the external electronic device.

6. A portable charging device, comprising:
a stylus module including:
a stylus body unit; and
a power supply unit arranged in the stylus body unit; and
a charging module including:
a casing unit including an opening, a first accommodating space, and a second accommodating space, the opening being communicated with the first accommodating space, and the first accommodating space being adjacent to the second accommodating space;
a control unit arranged in the second accommodating space; and
a receiving unit disposed on a main body of the casing unit, the receiving unit being electrically connected to the control unit;
wherein the stylus body unit is detachably arranged in the first accommodating space, and the power supply unit is electrically connected to the control unit; wherein, when the receiving unit receives a power from an external power supply, the control unit provides the power to the power supply unit.

7. The portable charging device according to claim 6, wherein the charging module further includes a plurality of light emitting units disposed on the main body of the casing unit, the light emitting units are electrically connected to the control unit; wherein at least one of the light emitting units emits a beam through being controlled by the control unit.
